(19) United States
(12) Patent Application Publication
(10) Pub. No.: US 2025/0125943 A1
(43) Pub. Date: Apr. 17, 2025

(54) OPTICAL ENSEMBLING SUCH AS FOR ATOMIC CLOCKS

(71) Applicant: ColdQuanta, Inc., Boulder, CO (US)

(72) Inventors: Robert James Fasano, Boulder, CO (US); Ronald Shane Fazzio, Denver, CO (US); Judith Olson, Northglenn, CO (US); Calvin Cahall, Broomfield, CO (US); Maximillian Adriano Perez, Boulder, CO (US); Karl Pendergast, Boulder, CO (US); Nathan Baltz, Chicago, IL (US)

(21) Appl. No.: 18/913,915

(22) Filed: Oct. 11, 2024

Related U.S. Application Data
(60) Provisional application No. 63/543,899, filed on Oct. 12, 2023.

(51) Int. Cl. H04L 7/00

(52) U.S. Cl. CPC H04L 7/0075

(57) ABSTRACT

An optical atomic clock can include a group of optical frequency references. A system for improving frequency stability in the clock output signal can use an optical combination of the group of optical frequency references. The system can include a first optical frequency reference comprising an output configured to generate a first optical signal; a second optical frequency reference comprising an output configured to generate a second optical signal; an optical frequency comparator configured to generate a first electrical feedback signal based on an optical combination of the first optical signal and the second optical signal; and an optical frequency comb, wherein the first optical frequency reference is configured to receive the first electrical feedback signal; and modify the first optical signal based on the first electrical feedback signal, wherein the optical frequency comb is configured to output a radio-frequency electrical signal based on the modified first optical signal.

### PRIORITY APPLICATIONS

This application claims the benefit of priority to U.S. Provisional Application Ser. No. 63/543,899, filed Oct. 12, 2023, the content of which is incorporated herein by reference in its entirety.

### BACKGROUND

Optical atomic clocks are precise timekeeping devices that use the quantum transitions of atoms to measure time. These clocks can operate by probing atomic transitions using laser light and locking the laser frequency to the atomic resonance. A clock signal is provided by using a frequency comb to convert the laser light in the optical domain to an electrical signal in the radio-frequency domain.

### BRIEF DESCRIPTION OF THE DRAWINGS

To easily identify the discussion of any particular element or act, the most significant digit or digits in a reference number refer to the figure number in which that element is first introduced.

FIG. 1 illustrates a block diagram of an optical clock.

FIG. 2 illustrates a block diagram of optical domain ensembling to generate a stable clock signal.

FIG. 3 illustrates a block diagram of ensembling two optical signals to stabilize a frequency comb.

FIG. 4 illustrates a block diagram of ensembling multiple optical signals to stabilize a frequency comb.

FIG. 5 illustrates a block diagram of optical domain ensembling in separate enclosures.

FIG. 6 illustrates a block diagram of optical domain ensembling across varying environmental conditions.

FIG. 7 illustrates a flowchart for generating a clock signal stabilized by optical domain ensembling of optical clocks.

FIG. 8 illustrates a flowchart for performing optical frequency comparison.

FIG. 9 and FIG. 10 illustrate additional block diagrams of ensembling multiple optical signals to stabilize a frequency comb.

FIG. 11 illustrates a block diagram of ensembling multiple optical signals in a digital implementation of an optical frequency comparator.

### DETAILED DESCRIPTION

Achieving and maintaining high frequency stability over both short and long time scales is a fundamental challenge. Environmental factors like temperature fluctuations, vibrations, and electromagnetic interference can affect stability. Optical atomic clock systems often involve sophisticated laser systems, vacuum chambers, and control electronics, making them complex and expensive to build and operate. Many applications would benefit from more compact and energy-efficient optical atomic clocks, but miniaturization while maintaining performance is challenging.

The stability challenges can be addressed by averaging several instances of an optical atomic clock, which contributes to the expense and size of the timekeeping system.

Advantageously, mechanisms to group multiple signals in the optical domain to stabilize a clock signal can reduce the use of a costly optical clock component (the frequency comb).

An atomic clock can include the following:
i) an atomic system,
ii) a local oscillator,
iii) interactions between the local oscillator and the atoms,
iv) detection of the frequency error between the local oscillator and a specified energy transition of the atoms (‘clock transition’), and
v) correction of the frequency error, bringing the local oscillator into agreement with the frequency of the clock transition.

Atomic clocks can use a clock transition that is in the radio-frequency electrical domain. Thus, atomic clocks can output an electrical clock signal that is able to interface with electronic components.

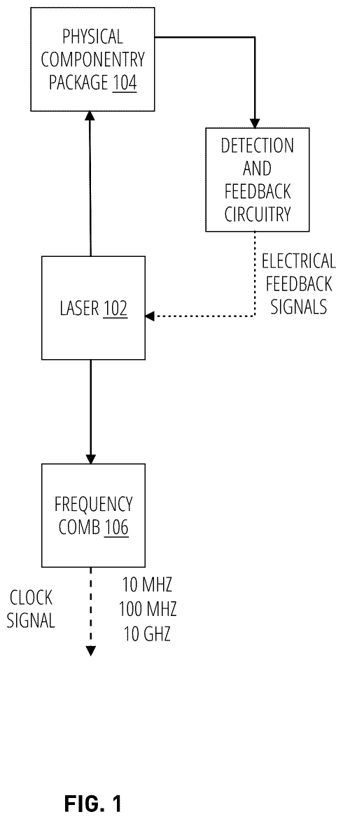

An optical atomic clock, such as that shown in the block diagram 100 of FIG. 1, can operate at optical frequencies. An optical atomic clock can include a laser 102 as the local oscillator, a physical componentry package 104 that includes or contains the atomic system with a clock transition in the hundreds of THz, a feedback loop (e.g., using one or more electrical signals based on detected fluorescence from the physical componentry package 104), and a frequency comb 106. The frequency comb 106 is an additional component for an optical-based atomic clock, and is used to transfer the optical frequency of the clock transition to a radio-frequency electrical signal. The frequency comb 106 can use the laser light stabilized to the clock transition as an input. In response, the frequency comb 106 can output an electrical signal in the radio-frequency electrical domain with approximately equal fractional frequency stability.

The laser 102 can be tunable or otherwise frequency-selectable across a certain wavelength range, or frequency range. For example, an external cavity diode laser can be tuned by adjusting the position or angle of external cavity mirrors. Any suitable laser technology can be used in laser 102.

The laser 102 can be optically coupled to the physical componentry package 104, and when the frequency is tuned, atoms in the physical componentry package 104 can interact with the lasers 102. For example, the physical componentry package 104 can include a thermal vapor, an ultracold gas, or any other suitable preparation of atoms (e.g., trapped ions), or a mechanical optical frequency reference such as an optical cavity implemented with any suitable cavity technology (e.g., stabilized mirrors in any suitable geometry, micro-resonator or photonic cavity in a photonic integrated circuit, etc.). When the laser 102 is resonant with an energy transition (or cavity mode) in the atoms (mechanical resonator) located in the physical componentry package 104, the atoms can transition from a ground state to a clock state. When the atoms cascade back down to the ground state, the atoms can emit fluorescence, from which a fluorescence signal can be generated. The laser 102 can be further modulated, and an error signal can be generated. The error signal can be anti-symmetric around the center frequency of the fluorescence signal. That is, when the laser 102 is detuned with a frequency slightly less (more) than the maximum of the fluorescence signal, the error signal can be positive (negative).

The error signal can be input to a proportional-integral-derivative (PID) or other controller such as to generate a stabilization signal. That is, the laser 102 can be locked to the atomic energy transition selected as the clock transition.

The laser output can be more stable once the laser 102 is locked to the atomic energy transition. The laser output can be converted from a signal in the optical domain to an electrical signal in the radio-frequency domain using the frequency comb 106 to down-convert the frequency of the stabilized laser signal. The frequency comb subsystem may include electronic signal conditioning to further convert the comb's repetition rate to one or more other frequencies of interest. An output electrical signal from the frequency comb 106 can include a range of frequencies encompassing ones of MHz, tens of MHz, hundreds of MHz, ones of GHz, tens of GHz, and hundreds of GHz, or combinations thereof, as illustrative examples.

The frequency comb 106 can comprise an ultra fast pulsed laser that has a frequency spectrum of a series of evenly spaced narrow lines. The repetition rate of the pulses can set the spacing of the spectra in the frequency spectrum, and this frequency spacing can be stabilized to the laser input. The repetition rate can be detected using a photodiode such as to provide an output electrical signal that can be used as a timing reference.

An ensemble is a group of clocks or oscillators whose outputs are averaged or otherwise combined such as to determine a central tendency to create a time scale with reduced noise compared to any single clock or oscillator. This can include taking several clock signals as input, and applying an averaging technique, which can be a simple average or can use various statistical or filtering techniques, which can include weighting different clock inputs based on their individual stability. For an optical atomic clock as described in FIG. 1, an ensemble can be formed by combining each output from several copies of the clock, thus involving a frequency comb 106 for each clock signal that is desired for the ensemble. Frequency combs can generally be an expensive component of an optical atomic clock. Techniques to ensemble an optical atomic clock without requiring the use of multiple frequency combs can be advantageous.

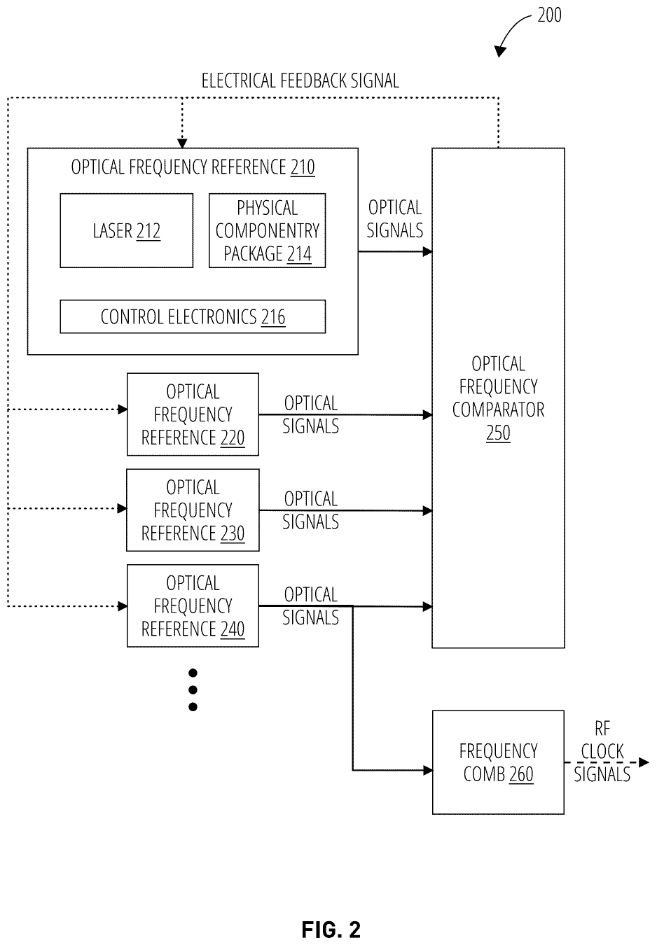

FIG. 2 illustrates an example of a block diagram of optical domain ensembling to generate a stable clock signal which can be performed in the optical domain. Optical domain ensembling can help provide a frequency stabilized optical input to a frequency comb. In FIG. 2, two or more optical frequency references (optical clocks) can be combined as an ensemble. Multiple optical frequency references 210, 220, 230, and 240 can be compared in the optical domain, such as using optical frequency comparator 250, for improved frequency stability, and can be input to a single frequency comb 260, which outputs a radio frequency electrical signal for use as a frequency-stabilized electrical clock signal.

In FIG. 2, an individual optical frequency reference 210 can comprise a laser 212, a physical componentry package 214, and control electronics 216. The laser 212, physical componentry package 214, and control electronics 216 can be substantially similar to the laser 102, physical componentry package 104, and feedback electronics described above in connection with FIG. 1. For example, at least one optical frequency reference 210, 220, 230, and 240 can be derived from an atomic or molecular energy transition. Several or each of the optical frequency references 210, 220, 230, and 240 can be derived from the same atomic or molecular energy transition, or alternatively, can be derived from different atomic or molecular energy transition(s).

Individual ones or each optical frequency reference 210 can have identical components. Components such as the laser 212 and physical componentry package 214 can differ between various optical frequency references 210. For example, the optical frequency reference 210 can employ a rubidium vapor, and the laser 212 can be configured to output coherent light corresponding to a two-photon clock transition of rubidium at 778 nm. In another example, the optical frequency reference 220 can use trapped strontium ions and the laser therein can be configured to output coherent light corresponding to the 674 nm clock transition.

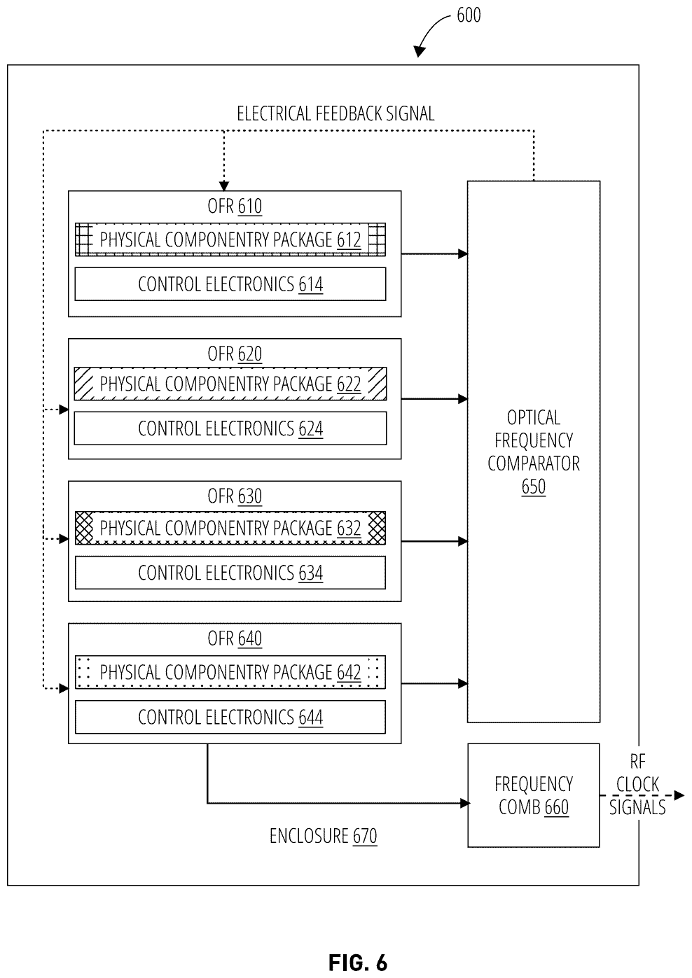

In addition, the control electronics 216 can include various devices for subjecting the optical frequency reference 210 to an environmental condition (e.g., heater, vibration unit, electric or magnetic field generator), such as discussed below in connection with FIG. 6.

The laser 212 can be any suitable laser system. For example, the laser 212 can be a pulsed laser or a continuous wave laser. The laser 212 can be implemented using any suitable laser technologies or lasing media, such as a diode laser, external cavity lasing, Ti-Sapphire crystal, etc. The laser 212 can include any suitable sub-systems (e.g., second harmonic generation) to achieve a wavelength resonant with an atomic or molecular transition in the physical componentry package 214. The laser 212 can be tunable across any suitable range of wavelengths while including the atomic or molecular transition resonance in the tunable range. The laser 212 can be tunable using any suitable tuning mechanism, such as tuning a cavity length, temperature of a component of the laser 212 (e.g., diode temperature), or any other suitable tuning mechanism.

The laser 212 and the physical componentry package 214 can be optically connected. For example, the light output by the laser 212 can be arranged to be incident on atoms of an atomic or molecular gas confined in the physical componentry package 214, such as to excite an energy transition of the atomic or molecular gas.

The physical componentry package 214 can comprise any suitable atomic or molecular species and any associated packaging, enclosure, electronics, and/or housing that may be desired for the laser 212 to interface with a given atomic or molecular energy transition of the particular atomic or molecular species. For example, the physical componentry package 214 can include one or more species of atomic gasses (e.g., alkali metal or alkaline earth metal, such as in a sealed vacuum cell) that can be cooled and/or trapped by laser 212, confined in a lattice arrangement, etc. In an example, the physical componentry package 214 can include ions that can be confined using an electrostatic or electrodynamic trap (e.g., Paul trap, surface trap on a chip substrate, etc.). Optionally, multiple species of atomic elements can be used to interface with a given atomic or molecular energy transition.

The physical componentry package 214 can include an atomic or molecular energy transition that has a transition frequency in the optical domain (near infra-red, visible, ultra-violet regions of the electromagnetic spectrum). In some examples, the physical componentry package 214 can include a high finesse cavity or other suitable mechanical resonator (e.g., ring resonator, photonic cavity on a photonic integrated chip).

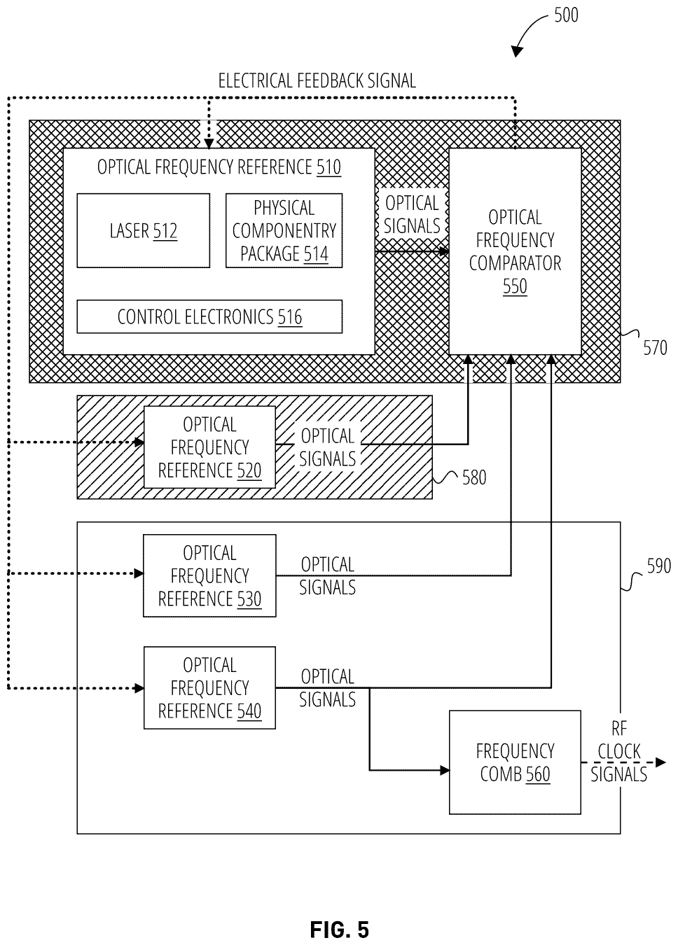

The control electronics 216 can include any suitable circuitry to control the laser 212 and/or the physical componentry package 214. For example, the control electronics 216 can include one or more power sources, electronic filters, circuitry to generate error signals (e.g., PID circuits) or phase locked loops, counters, and any other suitable analog or digital electronic components. For example, control electronics 216 can include one or more integrated circuits, digital circuitry, analog circuitry, I/O ports, and/or additional electronic devices such as thermometers, heaters, coolers (Peltier coolers, fans, etc.), display circuitry, detection circuitry (e.g., antennas, photodetectors), etc. As discussed below in connection with FIG. 5, the control electronics 216 can include components that can be configured to generate or to be responsive to various environmental conditions.

The optical outputs from optical frequency references 210, 220, 230, and 240 can be directed to an optical frequency comparator 250, which compares the signals in the optical domain. The optical outputs can be free-space outputs, fiber optical outputs, or a combination of free-space and fiber optic. Optical comparison of optical signals can be performed at the optical frequency comparator 250 through various techniques, such as can include optical heterodyne detection using a photodetector to electronically record beat notes between the optical signals.

An optical heterodyne approach within the optical frequency comparator can comprise a beamsplitter, including a first beamsplitter port to receive the first optical signal and including a second beamsplitter port to receive the second optical signal. The beamsplitter can output a combined optical signal.

The optical heterodyne approach can further comprise a first photodiode, configured to output a first photocurrent in response to the combined optical signal being incident on the first photodiode. The optical heterodyne technique can further comprise a beat note detector, which can be configured to detect a beat note in the first photocurrent and to output the first electrical feedback signal based on the beat note, wherein the beat note f_{beat} is a difference between a first frequency v₁ of the first optical frequency reference and a second frequency v₂ of the second optical frequency reference, f_{beat}=v₁−v₂. The beat note f_{beat} can be a much lower frequency that either of the two optical frequencies v₁ or v₂, and can be in a radio- or microwave-frequency range (e.g., kHz to GHz).

In some examples, a multi-stage optical heterodyne approach can be used. An optical frequency reference, such as optical frequency reference 210, can be selected as a “lead” reference. Then, all remaining optical frequency references can be used to generate an optical heterodyne signal with the lead reference. Each remaining reference can be combined (either on separate beam splitters, or iterating beams with an optical switch) with the lead reference on a beam splitter and detected by a photodiode.

An upper limit to the number of multi-stage optical heterodyne signals that can be generated can be determined by the optical power available for splitting in the lead reference, and the overall tradeoff between the cost of N OFRs and performance scaling of in the optical ensemble which scales as √N.

As a particular example using the optical frequency references 210-240, there are three optical heterodyne signals that can be generated using optical frequency reference 210 as a lead reference. The signals are as follows (with vₙ indicating the optical frequency for the optical frequency reference “n”).

$$\begin{matrix}{f}_{beat , 1} = {v}_{210} - {v}_{220} \\ {f}_{beat , 2} = {v}_{210} - {v}_{230} \\ {f}_{beat , 3} = {v}_{210} - {v}_{230} .\end{matrix}$$

These beat notes, carried on the electrical output signals of one or more photodetectors, can then be combined algorithmically, digitally, analog, or otherwise, such as through an averaging or other technique for determining a central tendency or an additional statistical technique such as a Kalman filter. In some examples, the signals can be weighted according to weighting criteria such as a frequency stability (e.g., long term, short term) of a given optical frequency reference.

In some examples, the optical frequency comparator 250 can generate an electrical signal (e.g., error signal) that can be used by the one or more optical frequency references 210 to produce a more stable frequency signal output. The control feedback signal generated by the optical frequency comparator 250 can be used to adjust one or more frequency references in the ensemble of optical frequency references 210-240. The adjustment can be implemented through various means, such as steering the one or more lasers 212 or using one or more modulators (e.g., acousto-optic modulators, AOMs) to modify the optical signals.

After adjustment, the optical output from the ensemble can be directed to a frequency comb 260. The frequency comb 260 can be any suitable frequency comb, such as an ultra fast pulsed laser that has a frequency spectrum of a series of evenly spaced narrow lines. In this example, the frequency spacing can be set by the repetition rate of the pulses. The repetition rate of the frequency comb 260, and therefore spacings of the frequency spectrum can be stabilized by any suitable stabilized optical input such as laser 212 or the optical output of optical frequency reference 210.

The frequency comb 260 converts the optical input to an electrical output signal in the radio-frequency (RF) domain. For example, the frequency comb 260 can output an RF electrical signal, e.g., carried by an electrical cable.

A frequency stability of the output RF signal from the frequency comb 260 can be improved such as by ensembling the optical frequency references in the optical domain. In some examples, frequency stability can be quantified through any suitable statistical measure, such as Allan variance (AVAR).

By using fewer combs, such as a single comb stabilized by multiple references, costs can be reduced. For example, as discussed above in connection to FIG. 1, applying certain approaches for creating a clock ensembles to optical clocks may involve a frequency comb for each optical clock or optical frequency reference in the ensemble. Then, the RF outputs (from the multiple frequency combs) can be averaged in the RF domain to generate a frequency stabilized clock signal. In the approach of FIG. 2, that is, ensembling multiple optical frequency references in the optical domain, followed by a single down-conversion technique (e.g., a single frequency comb), can help enable improved frequency stability performance while maintaining a cost-effective solution such as by reducing or minimizing the number of expensive frequency combs used.

The optical frequency references 210 can be co-located in the same enclosure (e.g., rack mount housing). Alternatively, the optical frequency references 210 can be distributed across different enclosures, as shown in FIG. 5, such as discussed below.

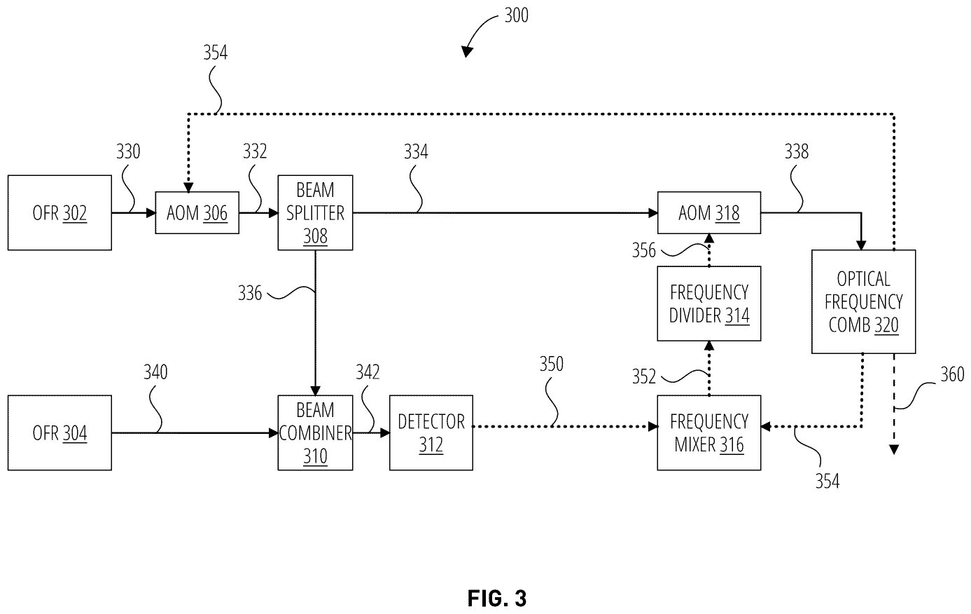

FIG. 3 illustrates a block diagram 300 of an example of ensembling two optical signals to stabilize a frequency comb. The ensembling technique shown in block diagram 300 can involve or consist of adding an offset frequency to a first reference, performing a heterodyne measurement with a second reference, generating an error signal, and adding the error signal to the first reference.

The block diagram 300 comprises a first optical frequency reference (OFR 302), a second optical frequency reference (OFR 304), an acousto-optic modulator (AOM) 306, a beam splitter 308, a beam combiner 310, a detector 312, a frequency divider 314, a frequency mixer 316, an AOM 318, and an optical frequency comb 320.

The OFR 302 can output a first optical signal 330. The optical signal 330 can have frequency v₁. For example, as described in FIG. 2, optical frequency reference 210 can use any suitable physical componentry package 214 to generate an optical output such as frequency-stabilized laser light or fluorescence from an atomic or molecular energy transition. In the example of FIG. 3, OFR 302 and OFR 304 can each comprise one of optical frequency reference 210, 220, 230, 240, or any other suitable optical frequency reference.

In some examples, the OFR 304 can output a second optical signal 340. The optical signal 340 can have frequency v₂, and can comprise frequency-stabilized laser light.

### Add Offset Frequency

The AOM 306 can receive and modulate the optical signal 330. In some examples, the AOM 306 can shift or offset the frequency v₁ of the optical signal 330. The amount of the frequency shift can be the frequency at which the AOM 306 is driven, that is, the frequency fᵣₑₚ of electrical signal 354. In some examples, a direct digital synthesizer (DDS) may be added to convert the frequency fᵣₑₚ of the comb to any suitable other frequency used to drive the AOM 306. In some examples, using the comb signal to drive the AOM 306 can avoid extra the use of additional electrical components which can be source(s) of additional electrical noise. Thus, the frequency noise added to the optical beam by the AOM 306 itself is negligible. The AOM 306 can output optical signal 332, which can have a frequency v_{1′}=v₁+fᵣₑₚ.

### Heterodyne Measurement

In some examples, the beam splitter 308 can divide the optical signal 332 according to an intensity ratio configured by the properties of the beam splitter 308. For example, the beam splitter 308 can include a 50:50 beamsplitter cube that outputs two optical signals that each have half of the intensity of the input optical signal. In this example, one optical signal is output from a transmission path through the beamsplitter cube and the other optical signal is output from a reflection path through the beamsplitter cube. The beam splitter 308 can have any suitable intensity ratio, such as 10:90, 60:40, etc., that describes the intensity ratio between the two output optical signals. The beam splitter 308 can be any suitable optic or photonic component, such as a fiber optic splitter.

The beam splitter 308 can output optical signals 334 and 336.

The optical signal 336 can be used for an optical heterodyne measurement with the optical signal 340, such as described below.

The beam combiner 310 can combine at least two optical signals, such as according to an intensity ratio set by the properties of the beam combiner 310. Similar to the beam splitter 308, the beam combiner 310 can, for example, include a 50:50 beam combiner cube (e.g., a beamsplitter cube operated with input signals at the output ports) that outputs one optical signal that equally combines the intensities of each input optical signal. The beam combiner 310 can be any suitable optic or photonic component, such as a fiber optic combiner.

The beam combiner 310 can output a combined optical signal 342 that can be a combination of optical signal 340 and optical signal 336.

The combined optical signal 342 can be arranged to be incident on detector 312, and detector 312 can generate an electrical signal 350 in response to the incident signal. The detector 312 can be any suitable energy detector, such as a photodiode, photo-multiplier tube, etc., that produces a photo-current in response to incident electromagnetic radiation.

### Generate Error Signal

The electrical signal 350 can comprise a frequency that is an absolute value of a difference between optical signal 336 and optical signal 340. That is, the electrical signal 350 can include components at a frequency f_{diff}=(v₁+fᵣₑₚ)−v₂. Further electronical signal processing of electrical signal 350 can be performed in a frequency range near f_{diff}. As the frequency difference of (v₂−v₁) is a very low frequency, by using the AOM 306 to add the frequency offset fᵣₑₚ, the further electronical signal processing of electrical signal 350 can avoid the influence of low-frequency noise in the electronic processing components.

In some examples, the frequency mixer 316 can output electrical signal 352 that can include components at a frequency f₄=f_{diff}+fᵣₑₚ=2×fᵣₑₚ+v₁−v₂. The mixer may also include appropriate radio frequency bandpass filters to isolate this mixing product from other mixing products produced by the frequency mixer 316.

In some examples, electrical signal 352 can be processed by further into electrical signal 356 by dividing the frequency, such as in half, at frequency divider 314. In this example, the electrical signal 356 can include components at a frequency

$${f}_{5} = \frac{{f}_{4}}{2} = {f}_{rep} + \frac{{v}_{1}}{2} - \frac{{v}_{2}}{2} .$$

This processing can be performed to generate an error signal that can be used to provide an average optical frequency during further processing (e.g., when subtracting the error signal from the first optical reference).
Subtract Error Signal from First Optical Reference

In some examples, electrical signal 356 can be used as a drive signal to AOM 318. In some examples, the AOM 318 can receive and modulate the optical signal 334. In some examples, the AOM 318 can shift or offset the frequency v_{1′} of the optical signal 334. The amount of the frequency shift can be the frequency at which the AOM 318 is driven, that is, frequency f₅ of electrical signal 356. The AOM can output optical signal 338, which can have a frequency

$${v}_{{1}^{″}} = \frac{{v}_{1} + {v}_{2}}{2} ,$$

where v_{1″} comprises the average frequency of the optical outputs of OFR 302 and OFR 304, that is,

$$\frac{{v}_{1} + {v}_{2}}{2} .$$

Thus, the block diagram 300 demonstrates an illustrative example of optical domain ensembling of two OFR inputs.

The optical signal 332 can be input to the optical frequency comb 320, which can be used to stabilize the repetition rate of the optical frequency comb 320. The stabilized repetition rate can be used as a clock output, as seen in FIG. 3 at comb output 360. As detailed above, comb output 360 can be stabilized using an optical signal containing the average of the optical outputs of OFR 302 an OFR 304, thus performing ensembling in the optical domain.

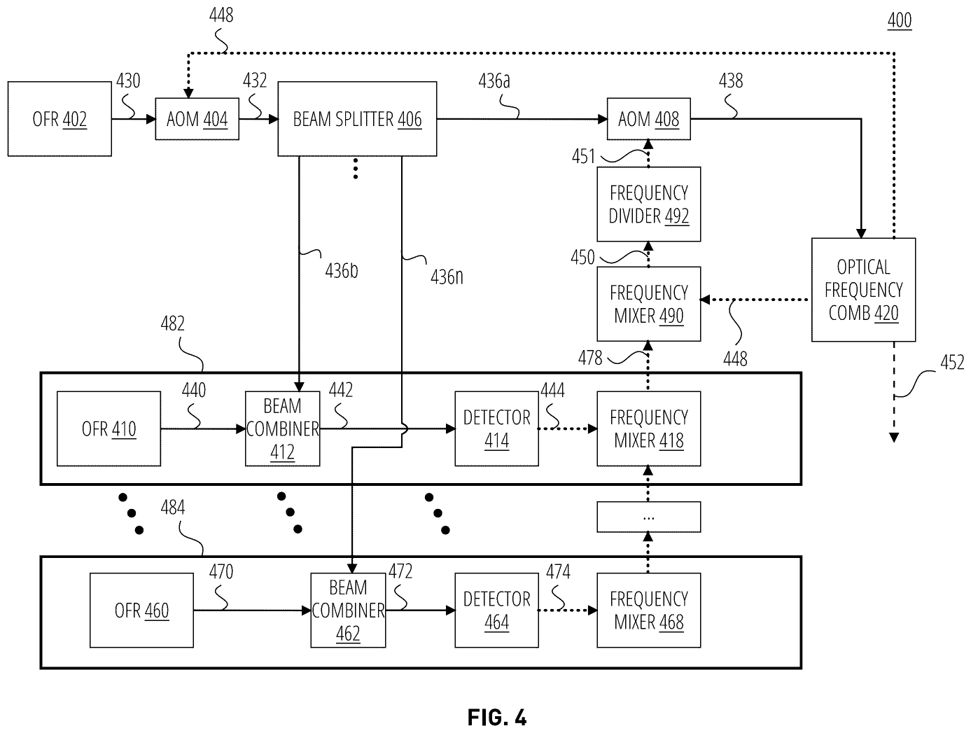

FIG. 4 illustrates a block diagram 400 of an example of ensembling multiple optical signals to stabilize a frequency comb. The ensembling technique shown in block diagram 400 can involve or consist of adding an offset frequency to a first lead reference, performing multiple heterodyne measurements (one for each pairing of the lead reference and each additional reference), generating an error signal (comprising a combination of the multiple heterodyne measurements), and adding the error signal to the lead reference. Block diagram 400 is an extension of the block diagram 300 discussed above in FIG. 3, and although two additional references are shown (OFR 410 and OFR 460), it can be understood that any suitable number (N−1) of additional references (for a total of N references) can be used in block diagram 400.

The block diagram 400 comprises a lead optical frequency reference (OFR 402), an acousto-optic modulator (AOM) 404, a beam splitter 406, a beam combiner 412, a detector 414, a frequency divider 416, a frequency mixer 418, an AOM 408, and an optical frequency comb 420. The block diagram 400 also comprises additional optical frequency references with additional opto-electronic components to create an optical average, seen in ancillary module 482 and ancillary module 484.

Each module of ancillary module 482 and 484 can comprise an optical frequency reference, a beam combiner, a detector, and a frequency mixer. Although only two ancillary modules 482 and 484 are shown in FIG. 4, it can be understood that (N−1) copies of ancillary modules can be included in block diagram 400. In the example shown in FIG. 4, N can be three.

### Add Offset Frequency

The OFR 402 can output a first optical signal 430. The optical signal 430 can have frequency Vi. As discussed above in block diagram 300, the first optical signal 430 can be offset by any suitable amount. As shown in FIG. 4, the first optical signal 430 can be shifted using AOM 404, which can be driven by the comb signal, that is, the frequency fᵣₑₚ of electrical signal 448, thus the optical signal 432 can have a frequency v_{1′}=v₁+fᵣₑₚ.

### Heterodyne Measurements

In some examples, the beam splitter 406 can divide the optical signal 432 according to an intensity ratio configured by the properties of the beam splitter 406. The beam splitter 406 can be any suitable optic or photonic component, such as a fiber optic splitter. For example, when there are (N−1) ancillary modules, the beam splitter 406 can be configured to output N beams. As shown in FIG. 4, the beam splitter 406 can output optical signals 436a through 436n.

The optical signal 436b can be directed to ancillary module 482, where it can be used for an optical heterodyne measurement with the optical signal 440. Similarly, optical signal 436n can be directed to ancillary module 484, where it can be used for an optical heterodyne measurement with the optical signal 470.

Each ancillary module 482, 484, and any additional ancillary modules not shown, can have an optical output combined with an optical signal from the beam splitter 406 combined on a respective beam combiner. For example, the optical signal 440 from OFR 410 can be combined with optical signal 436b at beam combiner 412, and the optical signal 470 from OFR 460 can be combined with optical signal 436n at beam combiner 462.

The beam combiner 412 can combine at least two optical signals, such as according to an intensity ratio set by the properties of the beam combiner 412. The beam combiner 412 can be any suitable optic or photonic component, such as a fiber optic combiner, and can output a combined optical signal 442 that can be a combination of optical signal 440 and optical signal 436b.

The combined optical signal 442 can be arranged to be incident on detector 414, and detector 414 can generate an electrical signal 444 in response to the incident signal. The detector 414 can be any suitable energy detector, such as a photodiode, photo-multiplier tube, etc., that produces a photo-current in response to incident electromagnetic radiation.

The beam combiner 462 can combine at least two optical signals, such as according to an intensity ratio set by the properties of the beam combiner 462. The beam combiner 462 can be any suitable optic or photonic component, such as a fiber optic combiner, and can output a combined optical signal 472 that can be a combination of optical signal 470 and optical signal 436n.

The combined optical signal 472 can be arranged to be incident on detector 464, and which can generate an electrical signal 474 in response to the incident signal. The detector 464 can be any suitable energy detector, such as a photodiode, photo-multiplier tube, etc., that produces a photo-current in response to incident electromagnetic radiation.

### Generate Error Signal

The electrical signal 444 can comprise a frequency that is an absolute value of a difference between optical signal 436b (having frequency v₁+fᵣₑₚ) and optical signal 440 (having frequency v₂). That is, the electrical signal 444 can include components at a frequency f_{diff}=fᵣₑₚ+v₁−v₂.

The electrical signal 474 can comprise a frequency that is an absolute value of a difference between optical signal 436n (having frequency v₁+fᵣₑₚ) and optical signal 470 (having frequency v_{N}). That is, the electrical signal 444 can include components at a frequency f_{diff,N}=fᵣₑₚ+v₁−v_{N}.

The frequency mixers 418 and 468 can be used to combine the electrical signal 474 and 444, along with any additional electrical signals from additional ancillary modules not shown, so that electrical signal 478 contains a summation of electrical signals from all ancillary modules,

$$( N - 1 ) \times {f}_{rep} + ( N - 2 ) \times {v}_{1} - {\sum }_{i = 2}^{N} {v}_{i}$$

In some examples, frequency mixer 490 can output electrical signal 450 that can include components at a frequency

$${f}_{error} = N \times {f}_{rep} + ( N - 1 ) \times {v}_{1} - {\sum }_{i = 2}^{N} {v}_{i} .$$

The mixer may also include appropriate radio frequency bandpass filters to operate in the electrical domain to isolate this mixing product from other frequency components produced in the frequency mixing.

In some examples, electrical signal 450 can be further processed into electrical signal 451 by dividing the frequency by a factor of N using frequency divider 492. In this example, the electrical signal 451 can include components at a frequency

$${f}_{N} = \frac{{f}_{error}}{N} = {f}_{rep} + \frac{( N - 1 )}{N} \times {v}_{1} - \frac{1}{N} \times {\sum }_{i = 2}^{N} {v}_{i} .$$

### Add Error Signal to First Optical Reference

In some examples, electrical signal 451 can be used as a drive signal to AOM 408. In some examples, the AOM 408 can receive and modulate the optical signal 436a. In some examples, the AOM 408 can shift or offset the frequency v_{1′} of the optical signal 436a. The amount of the frequency shift can be the frequency at which the AOM 408 is driven, that is, frequency fₑᵣᵣₒᵣ of electrical signal 450. The AOM can output optical signal 438, which can have a frequency

$${v}_{{1}^{″}} = {f}_{rep} + {v}_{1} - {f}_{N} = \frac{1}{N} {\sum }_{i = 1}^{N} {v}_{i} ,$$

where v_{1″} comprises the average frequency across all optical frequency references used.
   In some examples, an additional frequency mixer can be used to subtract the offset frequency component, fᵣₑₚ, so that v_{1″} is the average frequency across all optical frequency references used. Thus, the block diagram 400 demonstrates an illustrative example of optical domain ensembling across N optical inputs.

The optical signal 432 can be input to the optical frequency comb 420, which can be used to stabilize the repetition rate fᵣₑₚ of the optical frequency comb 420. The stabilized repetition rate can be used as a clock output, as seen in FIG. 4 at comb output 452.

FIG. 5 illustrates a block diagram 500 of an example of optical domain ensembling in separate enclosures.

When different enclosures are used, such as housing OFR 510 in enclosure 570, OFR 520 in enclosure 580, and OFRs 530 and 540 in enclosure 590, uncorrelated noise sources can be mitigated since each optical frequency reference can experience a slightly different shift in frequency. For example, the physical componentry package 514 in OFR 510 can experience an environmental condition which causes the energy transition to shift to a slightly higher energy (“blue shift”), while a physical componentry package in OFR 530 can experience a different environmental condition which causes the energy transition of the same atomic or molecular species to shift to a slightly lower energy (“red shift”). By having these two OFRs in separate enclosures, and in some examples, different physical locations, the red shift and blue shift can be incorporated into the error signal output by optical frequency comparator 550. In another example, the laser in OFR 520 can experience drift due to temperature changes in enclosure 580. Each of these effects can contribute to the electrical feedback signal in the optical frequency comparator 550.

The enclosures 570, 580, and 590 can communicate via one or multiple means, including fiber optic communications, free-space optical communications, RF communications, electrical communications, and/or other communications.

FIG. 6 illustrates a block diagram 600 of an example of optical domain ensembling across varying environmental conditions.

In the block diagram 600, one or more of the optical frequency references of OFR 610, OFR 620, OFR 630, and OFR 640 can be subjected to different external conditions.

The references OFR 610 through OFR 640 can reside in the same enclosure, as shown in enclosure 670. Alternatively, the references OFR 610 through OFR 640 can reside in different enclosures in any suitable combination.

FIG. 6 illustrates the physical componentry packages 612, 622, 632, and 642 under different thermal conditions, in an example of varying an environmental condition across the ensemble of optical frequency references. Other examples of environmental conditions can include varying a temperature, vibration, pressure, altitude, humidity, magnetic field, and/or electric field. In some examples, the differences in environmental conditions across the optical frequency references can occur on their own, such as when multiple enclosures are used, and when the enclosures are physically separated. In some examples, these environmental conditions can be generated intentionally, such as the temperature conditions shown in FIG. 6. In another example, OFR 610 can use the control electronics 614 to subject physical componentry package 612 to a vibration. Each physical componentry package may be subject to different values of an environmental condition, different environmental conditions, or combinations thereof. These environmental differences can help reduce or eliminate uncorrelated frequency shifts and reduce correlated variances.

The componentry shown in block diagram 600 can be used to sense and record the varying environmental conditions of the OFR 610 through 640. In some examples, the componentry shown in block diagram 500, showing OFR in various enclosures and in some examples, in various physical locations, can be used in combination with the block diagram 600.

The block diagram 600 can additionally include a control circuit, such as in the control electronics 614, configured to compare a value of the first electrical feedback signal to a single or composite criterion or a set of multiple criteria, and in response to comparing the value of the first electrical feedback signal to the criterion, convert the first electrical feedback signal to an indication of an environmental parameter.

The criterion can include any suitable threshold, range of values, or measure of variation or deviation from an average (or other central tendency) value of an environmental parameter. For example, the control circuit can be configured to record the first electrical feedback signal as a temperature (e.g., using a conversion parameter), when the first electrical feedback signal is outside of a range corresponding to a temperature range of 5 degrees Centigrade above or below a running average.

The criterion can be adapted to the physical units of the varying suitable environmental parameter. As a few non-limiting examples, the criterion can be a value or a range of: temperatures (in Celsius, Kelvin, or Fahrenheit), a magnetic field (in units of Tesla, Gauss, etc.), pressure (in mmHg, Torr, etc.), or altitude (in meters, feet, etc.).

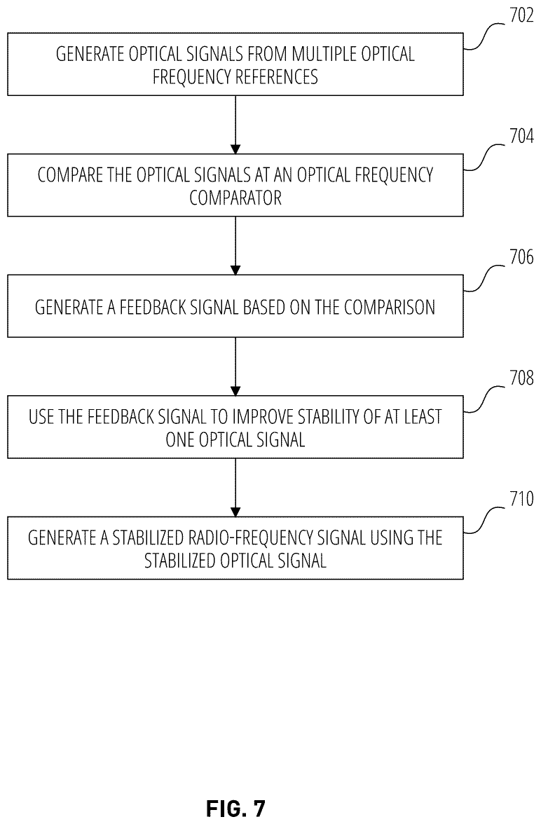

FIG. 7 illustrates a flowchart 700 for an example of generating a clock signal stabilized by optical domain ensembling of optical clocks. Although the example depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

At block 702, the method can include generating optical output signals from multiple optical frequency references. For example, the optical frequency reference 210 and the optical frequency reference 220 illustrated in FIG. 2 can be configured to each generate an optical output signal.

At block 704, the method can include receiving the optical output signals at an optical frequency comparator. For example, the optical frequency comparator 250 illustrated in FIG. 2 can be configured to receive the optical output signals.

At block 706, the method can include comparing the optical output signals. For example, the optical frequency comparator 250 illustrated in FIG. 2 can compare the optical output signals by optical heterodyne detection. In another example, the block diagram 300 can be used to compare the optical output signals.

At block 708, the method can include generating a comparison signal based on the optical comparison. For example, the optical frequency comparator 250 illustrated in FIG. 2 can generate a comparison signal based on the optical comparison.

At block 710, the method can include generating a control feedback signal based on the comparison signal. For example, the optical frequency comparator 250 illustrated in FIG. 2 can generate a control feedback signal based on the comparison signal.

At block 712, the method can include adjusting at least one of the optical frequency references based on the control feedback signal. For example, the optical frequency reference 210 illustrated in FIG. 2 can adjust the laser 212 through control electronics 216 based on the control feedback signal.

At block 714, the method can include generating an adjusted optical output from at least one of the optical frequency references. For example, the optical frequency reference 210 illustrated in FIG. 2 can generate an adjusted optical output from the physical componentry package 214 as a result of the adjustment to laser 212.

The method can include receiving the adjusted optical output at a frequency comb and generating an output radio-frequency signal at block 716. For example, the frequency comb 260 illustrated in FIG. 2 can down-convert the adjusted optical output and generate an output radio-frequency signal. In some examples, the output radio-frequency signal can have a stabilized frequency as a result of performing the blocks of flowchart 700.

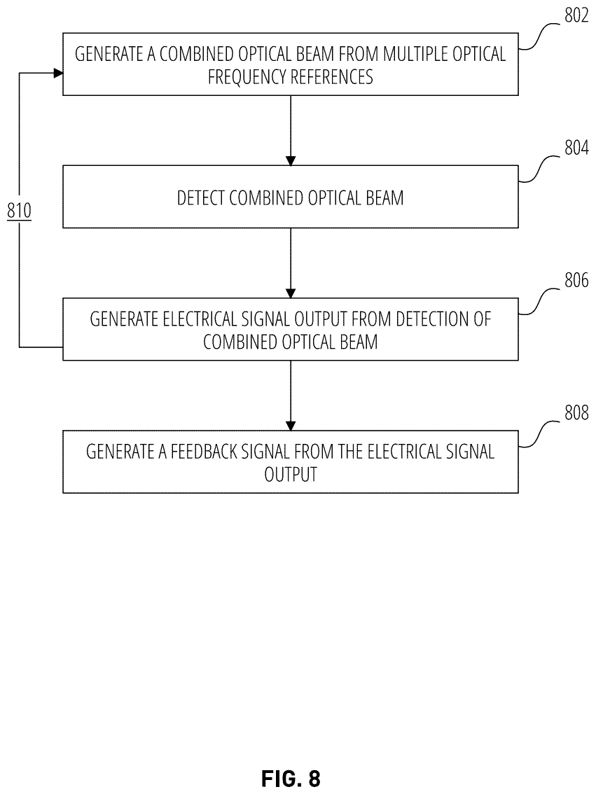

FIG. 8 illustrates an example of a routine for performing optical frequency comparison. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

At block 802, the method can include generating a combined optical beam from multiple optical frequency references. For example, a beam combiner can combine an optical output from a lead optical frequency references with another optical output from one of a remaining quantity of optical frequency references.

At block 804, the method can include detecting the combined optical beam.

At block 806, the method can include generating electrical signal output from detection of combined optical beam.

At 810, the method can iterate to combine additional optical beams to generate additional electrical signals. For example, as seen in FIG. 4, an optical output from a lead reference can be combined with N−1 additional optical outputs to generate N−1 electrical signals that can be combined.

At block 808, the method can include generating a feedback signal from the electrical signal output. For example, the method can detect a beat frequency in the electrical signal from block 806. In some examples, the method can average several beat frequencies, accumulated from multiple iterations of the method at 810.

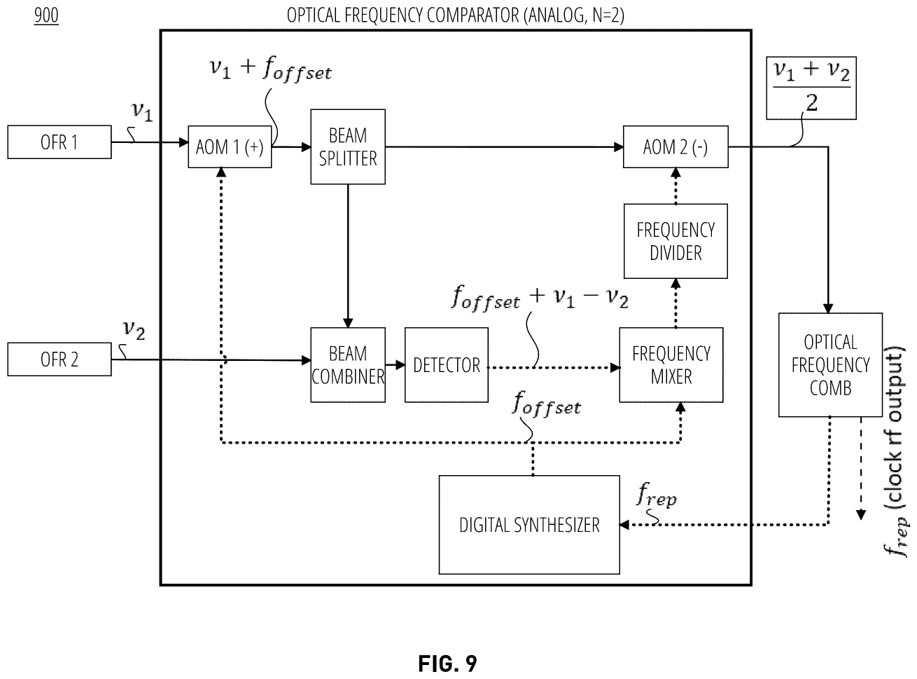

FIG. 9 illustrates a block diagram 900 of an example of ensembling two optical signals to stabilize a frequency comb. The block diagram 900 can be a more general diagram of the example block diagram 300 of FIG. 3. As indicated in FIG. 9, two optical frequency references (OFR 1 and OFR 2) are input to an analog implementation of an optical frequency comparator.

The optical output signal of OFR 1 can be directed through an AOM 1 and can receive a positive frequency shift (+) f_{offset}. The resulting optical output signal can be combined with the optical output signal of OFR 2, and the combined optical signal can be detected on a photodiode. The photodiode can produce an electronic signal having a frequency f_{offset}+v₁−v₂.

This electronic signal can be mixed at a frequency mixer with f_{offset}, producing an electronic signal as a mixing product that comprises 2×f_{offset}+v₁−v₂. Note that any additional mixing products (e.g., near DC) can be filtered out, for example using a highpass filter (not shown).

The electrical signal output from the frequency mixer can be divided by 2 and can be used to drive AOM 2. The optical output signal from AOM 1 (which contains a positive frequency shift of f_{offset}) can be input to AOM 2, which can produce a negative frequency shift (−) on the optical output signal from AOM 1. The combined effect of AOM 1 and AOM 2 on the optical output signal from OFR 1 can produce a total shift f_{offset}−(f_{offset}+(v₁−v₂)/2) such that a frequency of the optical signal at the output of AOM 2 comprises an average frequency (v₁+v₂)/2 of the two optical output signals from OFR 1 and OFR 2.

Note that any suitable additional components can be used. For example, electrical signal amplifiers (used to boost AOM drive frequencies) can be implemented but are not shown in FIG. 9.

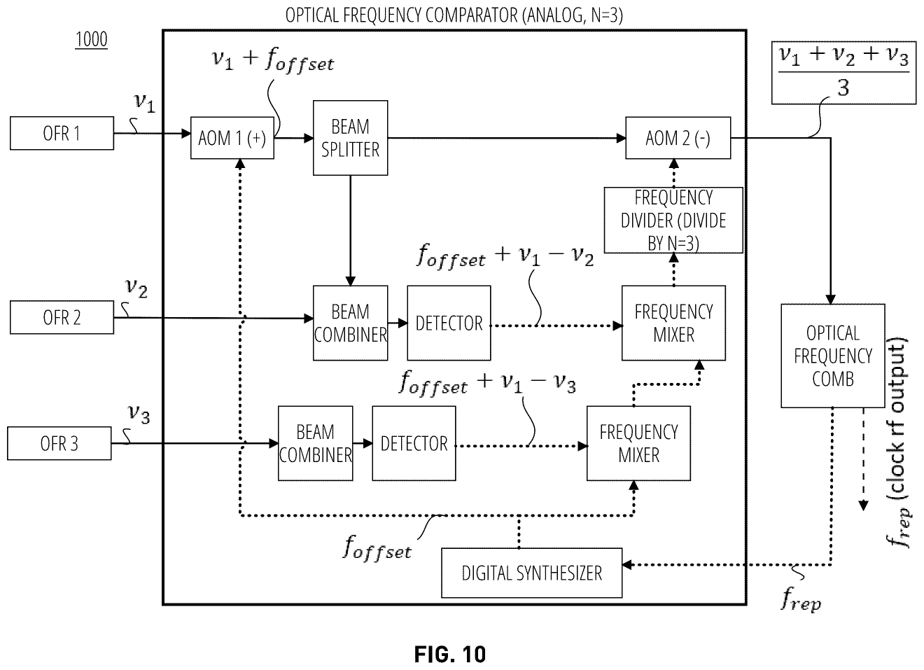

FIG. 10 illustrates a block diagram 1000 of an example of ensembling three optical signals to stabilize a frequency comb. As indicated in FIG. 10, three optical frequency references (OFR 1, OFR 2, and OFR 3) are input to an analog implementation of an optical frequency comparator, similarly to the block diagram 900 of FIG. 9.

The optical output signal of OFR 1 can be directed through an AOM 1 and can receive a positive frequency shift (+) f_{offset}. The resulting optical output signal can be combined with the optical output signal of OFR 2, and the combined optical signal can be detected on a first photodiode. This first photodiode can produce an electronic signal having a frequency f_{offset}+v₁−v₂. The resulting optical output signal can additionally be combined with the optical output signal of OFR 3, and the combined optical signal can be detected on a second photodiode. This second photodiode can produce an electronic signal having a frequency f_{offset}+v₁−v₃.

Multiple frequency mixers can be used to combine electronic signals to create an error signal. As shown in FIG. 10, the electronic signal having a frequency f_{offset}+v₁−v₃ can be input to a first frequency mixer, along with another electronic signal having frequency f_{offset}. The output of the first frequency mixer can be an electronic signal having frequency components at 2×f_{offset}+v₁−v₃. This electronic signal can then be input to a second frequency mixer, where the electronic signal output from the first photodiode (having frequency components f_{offset}+v₁−v₂) can be another input to the second frequency mixer. The output of the second frequency mixer can include an electronic signal having a frequency component at 3×f_{offset}+2×v₁−v₂−v₃.

This output electronic signal can have the frequency components divided by 3 (as indicated at the frequency divider), and the resulting electronic signal can be used to drive AOM 2. As in FIG. 9, AOM 2 can be used to produce a negative optical frequency shift (−) of

$${f}_{offset} + \frac{1}{3} \times ( 2 {v}_{1} - {v}_{2} - {v}_{3} ) .$$

The combined effect of AOM 1 and AOM 2 on the optical output signal from OFR 1 can be to produce a total shift of f_{offset}−(f_{offset}+(v₁−v₂−v₃)/3) such that a frequency of the optical signal at the output of AOM 2 comprises an average frequency (v₁+v₂+v₃)/3 of the three optical output signals from OFR 1, OFR 2, and OFR 3.

Extension to arbitrary numbers N of OFRs (that is, N>3) can be achieved by cascading mixers as shown in the example of FIG. 10. The general case of using N OFRs comprises: a 1×N beamsplitter for the lead OFR (OFR 1), N−1 each of beam combiners and photodiodes (a paired beam combiner and photodetector can also be considered or replaced with any other suitable “beat detector”), N−1 frequency mixers, and a “divide-by-N” frequency division on the electronic signal driving AOM 2.

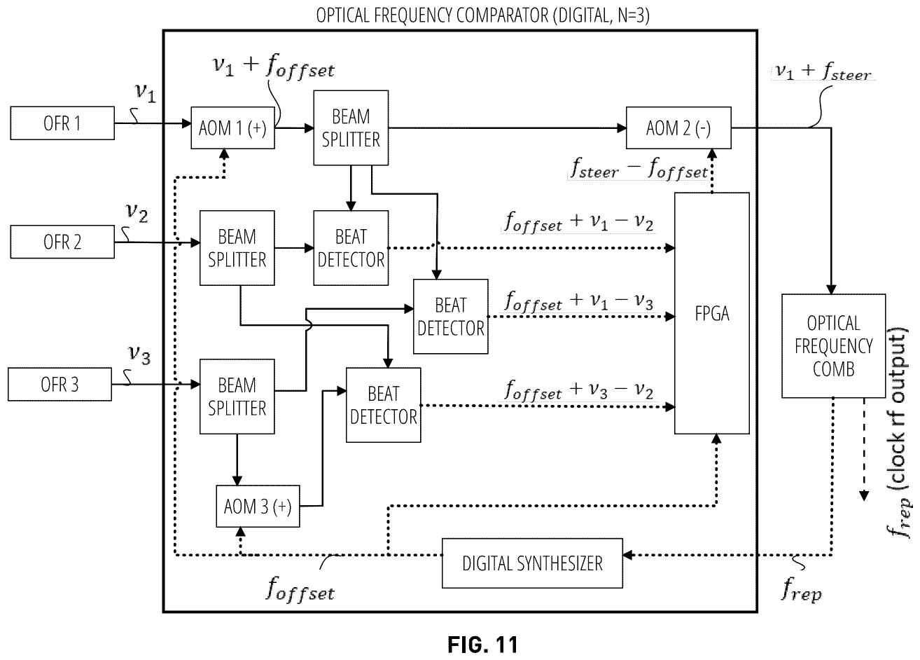

FIG. 11 illustrates a block diagram 1100 of an example of ensembling three optical signals using a digital implementation of an optical frequency comparator. As indicated in FIG. 10, three optical frequency references (OFR 1, OFR 2, and OFR 3) are input to a digital implementation of an optical frequency comparator.

The generation of electrical output signals can follow a similar technique to that shown in FIG. 9 and FIG. 10. That is, each optical frequency reference can be input to one or more “beat detectors” (comprising a beam combiner and photodiode). The optical output signal of OFR 1 can be directed through an AOM 1 and can receive a positive frequency shift (+) f_{offset}. The resulting optical output signal can be combined with the optical output signal of OFR 2, and the combined optical signal can be detected on a first photodiode. This first photodiode can produce an electronic signal having a frequency f_{offset}+v₁−v₂. The resulting optical output signal can additionally be combined with the optical output signal of OFR 3, and the combined optical signal can be detected on a second photodiode. This second photodiode can produce an electronic signal having a frequency f_{offset}+v₁−v₃.

A portion of optical output signal of OFR 3 can be directed through an AOM 3 and can receive a positive frequency shift (+) f_{offset}. The resulting optical output signal can be combined with the optical output signal of OFR 2, and the combined optical signal can be detected on a third photodiode. This third photodiode can produce an electronic signal having a frequency f_{offset}+v₁−v₃.

With three electronic signals, the electronic outputs of the beat detectors can be input to a field-programmable gate array (FPGA). The FPGA can be clocked with any suitable frequency, such as f_{offset} or fᵣₑₚ to guarantee that its additive noise is minimal. The FPGA can measure the instability of the three input electronic beat signals. The FPGA can additionally apply any suitable technique, such as the three-cornered-hat technique, to determine individual instabilities of the three OFRs. An electronic signal output from the FPGA can apply a steering correction to OFR 1 by driving AOM 2. In contrast to the analog implementation of the optical frequency comparator, seen in FIG. 9 and FIG. 10, the optical output from AOM 2 can be equal to any suitable combination of the three optical frequencies. That is, the optical output from AOM 2 can be a weighted average of OFR frequencies, where each OFR contribution to the weighting can be determined (e.g., internal to the FPGA) according to a frequency stability criteria, and can be applied through the electronic output signal of the FPGA.

A numbered list of non-limiting examples is included below. Example 1 is a system for improving frequency stability in a group of optical frequency references, the system can comprise: a first optical frequency reference comprising an output configured to generate a first optical signal; a second optical frequency reference comprising an output configured to generate a second optical signal; an optical frequency comparator configured to generate a first electrical feedback signal based on an optical combination of the first optical signal and the second optical signal; and an optical frequency comb; wherein the first optical frequency reference can be configured to: receive the first electrical feedback signal; and modify the first optical signal based on the first electrical feedback signal; and wherein the optical frequency comb can be configured to output a radio-frequency electrical signal based on the modified first optical signal.

In Example 2, the subject matter of Example 1 can optionally include, wherein modifying the first optical signal based on the first electrical feedback signal improves a frequency stability of the first optical signal, and wherein the optical frequency comb transmits an indication of the frequency stability to the radio-frequency electrical signal.

In Example 3, the subject matter of Examples 1-2 can optionally include, wherein the optical frequency comparator includes an optical heterodyne detector comprising: a beamsplitter, including a first beamsplitter port to receive the first optical signal and including a second beamsplitter port to receive the second optical signal, wherein the beamsplitter outputs a combined optical signal; a first photodiode, configured to output a first photocurrent in response to the combined optical signal being incident on the first photodiode; and a beat note detector, configured to detect a beat note in the first photocurrent and to output the first electrical feedback signal based on the beat note, wherein the beat note is a difference between a first frequency of the first optical frequency reference and a second frequency of the second optical frequency reference.

In Example 4, the subject matter of Example 3 can optionally include, wherein the optical frequency comparator comprises: a frequency modulator, configured to generate a modulated first optical signal by shifting a frequency of the first optical signal by an amount determined using the first electrical feedback signal; wherein the optical heterodyne detector is configured to: combine the modulated first optical signal and the second optical signal on the optical heterodyne detector to generate the beat note; generate a further modulated first optical signal by further shifting a frequency of the modulated first optical signal by an amount determined using a combination of the beat note and a frequency of the first electrical feedback signal; and generate the first electrical feedback signal at an optical frequency comb using the further modulated first optical signal; wherein the optical frequency comb is further configured to output a radio-frequency electrical signal based on the further modulated first optical signal.

In Example 5, the subject matter of Examples 1-4 can optionally include, a third optical frequency reference having a third optical signal; wherein the optical frequency comparator is further configured to generate a second electrical feedback signal based on the first optical signal, the second optical signal, and the third optical signal; wherein the first optical frequency reference is configured to: receive the second electrical feedback signal; and output a modified first optical signal based on the second electrical feedback signal.

In Example 6, the subject matter of Example 5 can optionally include, wherein the optical frequency comparator is a multi-stage heterodyne detector comprising: a first beamsplitter, including a first beamsplitter port to receive the first optical signal and including a second beamsplitter port to receive the second optical signal, wherein the first beamsplitter outputs a first combined optical signal; a first photodiode, configured to output a first photocurrent in response to the first combined optical signal being incident on the first photodiode; a second beamsplitter, including a third beamsplitter port to receive the first optical signal and including a fourth beamsplitter port to receive the third optical signal, wherein the second beamsplitter outputs a second combined optical signal; a second photodiode, configured to output a second photocurrent in response to the second combined optical signal being incident on the second photodiode; and a beat note detector, configured to: detect a first beat note in the first photocurrent, wherein the first beat note is a difference between a first frequency of the first optical frequency reference and a second frequency of the second optical frequency reference; detect a second beat note in the second photocurrent, wherein the second beat note is a difference between a first frequency of the first optical frequency reference and a third frequency of the third optical frequency reference; and output the first electrical feedback signal based on a combination of the first beat note and the second beat note.

In Example 7, the subject matter of Examples 1-6 can optionally include, wherein the second optical signal is responsive to an environmental condition.

In Example 8, the subject matter of Example 7 can optionally include, wherein the environmental condition is at least one of: a temperature, a vibration, a pressure, a magnetic field, or an electric field.

In Example 9, the subject matter of Example 8 can optionally include, wherein a response of the second optical signal to the environmental condition comprises a frequency shift of the second optical signal.

In Example 10, the subject matter of Examples 8-9 can optionally include, a control circuit configured to: compare a value of the first electrical feedback signal to a criterion; and in response to comparing the value of the first electrical feedback signal to the criterion, convert the first electrical feedback signal to an indication of an environmental parameter.

In Example 11, the subject matter of Example 10 can optionally include, wherein the environmental parameter comprises a physical unit of measurement corresponding to the environmental condition.

In Example 12, the subject matter of Examples 1-11 can optionally include, wherein at least one of the first optical frequency reference and the second optical frequency reference are derived from an atomic or molecular energy transition.

In Example 13, the subject matter of Example 12 can optionally include, wherein the first optical frequency reference uses a different atomic or molecular energy transition than the second optical frequency reference.

In Example 14, the subject matter of Examples 12-13 can optionally include, wherein at least one of the first optical frequency reference and the second optical frequency reference are derived from a laser incident on a high-finesse optical resonator.

Example 15 is a method for combining at least one optical frequency reference in a group of optical frequency references, the method can comprise: generating a plurality of optical signals from a plurality of optical frequency references; comparing the plurality of optical signals using an optical frequency comparator; generating a control feedback signal at the optical frequency comparator based on comparing the plurality of optical signals; adjust at least one of the optical frequency references based on the control feedback signal, resulting in at least one modified optical signal from the adjustment to the at least one of the optical frequency references; and generating a radio-frequency signal at an optical frequency comb based on the at least one modified optical signal being input to the optical frequency comb.

In Example 16, the subject matter of Example 15 can optionally include, wherein the optical frequency comparator comprises an optical heterodyne detector comprising a photodetector configured to detect a beat note between at least two optical signals in the plurality of optical signals.

In Example 17, the subject matter of Examples 15-16 can optionally include, wherein the optical frequency comparator comprises a multi-stage heterodyne detector comprising: selecting a lead optical frequency reference from the plurality of optical frequency references; comparing the lead optical frequency reference with a remaining reference from the plurality of optical frequency references using an optical heterodyne detector, wherein the optical heterodyne detector comprises a photodetector configured to detect a beat note between the lead optical frequency reference and the remaining reference; and generating a control feedback signal based on a combination of one or more beat notes resulting from one or more comparisons of the lead optical frequency reference with a remaining reference.

In Example 18, the subject matter of Examples 15-17 can optionally include, subjecting at least two of the optical frequency references to different environmental conditions.

In Example 19, the subject matter of Examples 15-18 can optionally include, wherein at least one optical frequency reference in the plurality of optical frequency references is derived from an atomic or molecular energy transition.

Example 20 is at least one machine-readable medium including instructions that, when executed by processing circuitry, can optionally cause the processing circuitry to perform operations to implement of any of Examples 1-19.

Example 21 is an apparatus optionally comprising means to implement of any of Examples 1-19.

Other technical features and example embodiments may be readily apparent to one skilled in the art from the figures, descriptions, and claims herein.

A detailed description of one or more embodiments of the invention is provided above along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the preceding description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a computer-readable storage medium refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

As used herein, a machine storage medium refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media.

As used herein, a non-transitory computer-readable storage medium refers, for example, to a tangible medium that is capable of storing, encoding, or carrying the instructions for execution by a machine.

It will also be understood that, although the terms first, second, etc. are, in some instances, used herein to describe various elements, these elements should not be limited by these terms. These terms are used only to distinguish one element from another. For example, a first tuner could be termed a second tuner, and, similarly, a second tuner could be termed a first tuner, without departing from the scope of the various described embodiments. The first tuner and the second tuner are both tuners, but they are not the same tuner.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A system for improving frequency stability in a group of optical frequency references, the system comprising:
a first optical frequency reference comprising an output configured to generate a first optical signal;
a second optical frequency reference comprising an output configured to generate a second optical signal;
an optical frequency comparator configured to generate a first electrical feedback signal based on an optical combination of the first optical signal and the second optical signal;
an optical frequency comb; and
wherein the first optical frequency reference is configured to:
receive the first electrical feedback signal; and
modify the first optical signal based on the first electrical feedback signal;
wherein the optical frequency comb is configured to output a radio-frequency electrical signal based on the modified first optical signal.

2. The system of claim 1, wherein modifying the first optical signal based on the first electrical feedback signal improves a frequency stability of the first optical signal, and wherein the optical frequency comb transmits an indication of the frequency stability to the radio-frequency electrical signal.

3. The system of claim 1, wherein the optical frequency comparator includes an optical heterodyne detector comprising:
a beamsplitter, including a first beamsplitter port to receive the first optical signal and including a second beamsplitter port to receive the second optical signal, wherein the beamsplitter outputs a combined optical signal;
a first photodiode, configured to output a first photocurrent in response to the combined optical signal being incident on the first photodiode; and
a beat note detector, configured to detect a beat note in the first photocurrent and to output the first electrical feedback signal based on the beat note, wherein the beat note is a difference between a first frequency of the first optical frequency reference and a second frequency of the second optical frequency reference.

4. The system of claim 3, wherein the optical frequency comparator comprises:
a frequency modulator, configured to generate a modulated first optical signal by shifting a frequency of the first optical signal by an amount determined using the first electrical feedback signal; and
wherein the optical heterodyne detector is configured to:
combine the modulated first optical signal and the second optical signal on the optical heterodyne detector to generate the beat note;
generate a further modulated first optical signal by further shifting a frequency of the modulated first optical signal by an amount determined using a combination of the beat note and a frequency of the first electrical feedback signal; and
generate the first electrical feedback signal at an optical frequency comb using the further modulated first optical signal;
wherein the optical frequency comb is further configured to output a radio-frequency electrical signal based on the further modulated first optical signal.

5. The system of claim 1, further comprising:
a third optical frequency reference having a third optical signal; and
wherein the optical frequency comparator is further configured to generate a second electrical feedback signal based on the first optical signal, the second optical signal, and the third optical signal;
wherein the first optical frequency reference is configured to:
receive the second electrical feedback signal; and
output a modified first optical signal based on the second electrical feedback signal.

6. The system of claim 5, wherein the optical frequency comparator is a multi-stage heterodyne detector comprising:
a first beamsplitter, including a first beamsplitter port to receive the first optical signal and including a second beamsplitter port to receive the second optical signal, wherein the first beamsplitter outputs a first combined optical signal;
a first photodiode, configured to output a first photocurrent in response to the first combined optical signal being incident on the first photodiode;
a second beamsplitter, including a third beamsplitter port to receive the first optical signal and including a fourth beamsplitter port to receive the third optical signal, wherein the second beamsplitter outputs a second combined optical signal;
a second photodiode, configured to output a second photocurrent in response to the second combined optical signal being incident on the second photodiode; and
a beat note detector, configured to:
detect a first beat note in the first photocurrent, wherein the first beat note is a difference between a first frequency of the first optical frequency reference and a second frequency of the second optical frequency reference;
detect a second beat note in the second photocurrent, wherein the second beat note is a difference between a first frequency of the first optical frequency reference and a third frequency of the third optical frequency reference; and
output the first electrical feedback signal based on a combination of the first beat note and the second beat note.

7. The system of claim 1, wherein the second optical signal is responsive to an environmental condition.

8. The system of claim 7, wherein the environmental condition is at least one of: a temperature, a vibration, a pressure, a magnetic field, or an electric field.

9. The system of claim 8, wherein a response of the second optical signal to the environmental condition comprises a frequency shift of the second optical signal.

10. The system of claim 8, further comprising a control circuit configured to:
compare a value of the first electrical feedback signal to a criterion; and
in response to comparing the value of the first electrical feedback signal to the criterion, convert the first electrical feedback signal to an indication of an environmental parameter.

11. The system of claim 10, wherein the environmental parameter comprises a physical unit of measurement corresponding to the environmental condition.

12. The system of claim 1, wherein at least one of the first optical frequency reference and the second optical frequency reference are derived from an atomic or molecular energy transition.

13. The system of claim 12, wherein the first optical frequency reference uses a different atomic or molecular energy transition than the second optical frequency reference.

14. The system of claim 12, wherein at least one of the first optical frequency reference and the second optical frequency reference are derived from a laser incident on a high-finesse optical resonator.

15. A method for combining at least one optical frequency reference in a group of optical frequency references, the method comprising:
generating a plurality of optical signals from a plurality of optical frequency references;
comparing the plurality of optical signals using an optical frequency comparator;
generating a control feedback signal at the optical frequency comparator based on comparing the plurality of optical signals;
adjust at least one of the optical frequency references based on the control feedback signal, resulting in at least one modified optical signal from the adjustment to the at least one of the optical frequency references; and
generating a radio-frequency signal at an optical frequency comb based on the at least one modified optical signal being input to the optical frequency comb.

16. The method of claim 15, wherein the optical frequency comparator comprises an optical heterodyne detector comprising a photodetector configured to detect a beat note between at least two optical signals in the plurality of optical signals.

17. The method of claim 15, wherein the optical frequency comparator comprises a multi-stage heterodyne detector comprising:
selecting a lead optical frequency reference from the plurality of optical frequency references;
comparing the lead optical frequency reference with a remaining reference from the plurality of optical frequency references using an optical heterodyne detector, wherein the optical heterodyne detector comprises a photodetector configured to detect a beat note between the lead optical frequency reference and the remaining reference; and
generating a control feedback signal based on a combination of one or more beat notes resulting from one or more comparisons of the lead optical frequency reference with a remaining reference.

18. The method of claim 15, further comprising subjecting at least two of the optical frequency references to different environmental conditions.

19. The method of claim 15, wherein at least one optical frequency reference in the plurality of optical frequency references is derived from an atomic or molecular energy transition.
